(19) United States
(12) Patent Application Publication
(10) Pub. No.: US 2021/0000151 A1
(43) Pub. Date: Jan. 7, 2021

(54) COMPOSITION AND PROCESS FOR PREPARING NATURAL OLIVE PULP-BASED FOOD SUBSTANCE

(71) Applicant: Kvutzat Yavne Food Products Ltd., D.N. Evtach (IL)

(72) Inventors: Arturo GEIFMAN, Hod Hasharon (IL); Tal LEIZER, D.N. Evtach (IL)

(73) Assignee: Kvutzat Yavne Food Products Ltd., D.N. Evtach (IL)

(21) Appl. No.: 16/929,407

(22) Filed: Jul. 15, 2020

Related U.S. Application Data
(63) Continuation of application No. PCT/US2019/013608, filed on Jan. 15, 2019.
(60) Provisional application No. 62/617,325, filed on Jan. 15, 2018.

(51) Int. Cl. A23L 19/00; A23L 33/185; A23L 27/10; A23P 30/10

(52) U.S. Cl. CPC A23L 19/09; A23P 30/10; A23L 27/10; A23L 33/185

(57) ABSTRACT

A process for preparing natural olive pulp-based food substance is provided. In an embodiment the process includes mixing a portion of olive pulp with at a portion of a plant-based protein into a composition; heating the composition; adding a portion of taste substance to the composition; and refrigerating the composition in at least one mold, wherein the refrigerated composition is a natural pulp-based food substance.

### CROSS-REFERENCE TO RELATED APPLICATIONS

This application is a continuation of International Patent Application No. PCT/US2019/013608 filed on Jan. 15, 2019, now pending, which claims the benefit of U.S. Provisional Application No. 62/617,325 filed on Jan. 15, 2018, the contents of which are hereby incorporated by reference.

### TECHNICAL FIELD

The disclosure relates to the processing of plant-based foodstuff, and more specifically to a process of incorporating olive pulp composition.

### BACKGROUND

A dairy is a business enterprise established for the harvesting and/or processing of animal milk for human consumption. A dairy is typically located on a dedicated dairy farm or in a section of a multi-purpose farm that is concerned with the harvesting of milk. Dairy products include, for example: cream and butter, skimmed milk, casein, cheese, whey, yogurt, milk powders, etc.

Dairy products are controversial these days. Experts claim that dairy is harmful and should be avoided. One common argument against dairy products, is that it is “unnatural” to consume them. None the less, humans are the only species that consume milk in adulthood and certainly the only species that consume the milk from another animal.

Furthermore, the main carbohydrate in dairy is lactose, a “milk sugar” that is made of the two simple sugars: glucose and galactose. For infants, the human body produces a digestive enzyme: “lactase”. This enzyme breaks down lactose in the milk that comes from a woman's breast. It is claimed that many women lose this “enzyme break down” ability once they reach adulthood.

Specifically, research shows that about 75% of the world's population is unable to break down lactose as adults, a phenomenon called lactose intolerance. People who are lactose intolerant have digestive symptoms when they consume dairy products. This includes nausea, vomiting, diarrhea and related symptoms. Some people can also be allergic to other components in milk, like the proteins. This is fairly common in children, but rare in adults.

Therefore, these days, dairy substitutes are becoming increasingly popular with products made from soy, different types of nuts, oats, hemp, and the like. However, such substitutes tend to include large amount of synthetic substances which are considered highly unhealthy. Due to the high frequency of consumption of dairy substitutes it is becoming a widespread issue.

The dairy alternatives market is estimated at around 5 billion US dollars and expected to be worth more than 35 Billion USD by 2022. The rise is directly connected to trends people are following. Such trends include the exclusion of animal-based products from their diet due to ideological reasons and/or health reasons, e.g., lactose sensitivity.

It would be advantageous to therefore provide a process that would enable the generation of a dairy substitute which is based on natural substances.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a process for preparing natural olive pulp-based food substance. The process comprises mixing a portion of olive pulp with a portion of a plant-based protein into a composition; heating the composition; adding a portion of taste substance to the composition; and then refrigerating the composition in at least one mold, wherein the refrigerated composition is a natural pulp-based food substance.

Certain embodiments disclosed herein also include a natural olive pulp-based food substance comprising a mixture of a portion of olive pulp with a portion of a plant-based protein, with a portion of taste substance added to the mixture.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a flowchart of a process for preparing and packaging an olive pulp composition in accordance with some embodiments.

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

It is important to note that the embodiments disclosed herein are only examples of the many advantageous uses of the innovative teachings herein. In general, statements made in the specification of the present application do not necessarily limit any of the various claims. Moreover, some statements may apply to some inventive features but not to others. In general, unless otherwise indicated, singular elements may be in plural and vice versa with no loss of generality.

A process for incorporating olive pulp composition is disclosed. The process comprises: the addition of at least one type of plant-based protein, with a mixture of fat and water to form one single composition. Thereafter, adding olive pulp to the composition and heating the composition. The olive pulp may be generated using a pulper machine. At least one taste substance is added to the composition before the composition is refrigerated into at least one mold.

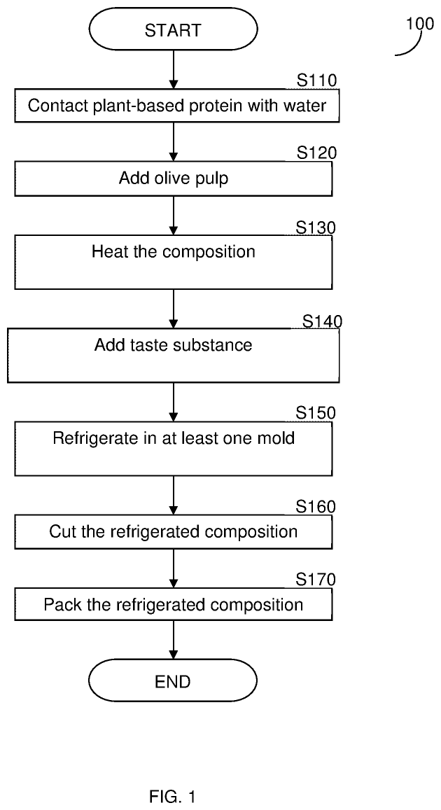

FIG. 1 depicts an example flowchart 100 depicting the process of preparing and packaging a natural olive pulp-based food substance in accordance with an embodiment.

At S110, a plant-based protein is mixed with water to a composition. The plant-based protein may be, for example, soy, lentils, hemp seeds, chia seeds, quinoa, spirulina, almonds, walnuts, cashews, pistachios, brazil nuts, and the like. The portion of plan-based protein is to constitute up to 20% of the food substance. The food substance is the product of the disclosed process.

At S120, a portion of olive pulp is added to the composition. Olive pulp is to constitute up to 40% of the food substance. Olive pulp, sometimes referred to as olive pomace or olive cake is what remains after olives are crushed and the olive oil is extracted. Olive pulp contains the pulp, skins, stones and water. Olive pulp constitutes between 50% and 80% (depending on extraction method) of the original olive weight. The nutrient composition of olive pulp is affected by the olive variety, method used to extract the oil, season and agronomic conditions plus the impact of how and for how long the olive pulp is stored. According to another embodiment, the olive pulp may be generated via a pulper machine. According to another embodiment, additional portions of the olive may be added to the composition, e.g., the olive's shell and/or the olives themselves.

At S130, the composition is mixed and heated in a thermal treatment until a homogenous composition is generated. The heating process may be degradable, e.g., different levels of heat through time. The thermal treatment of the composition is performed so as to address biological issues resulting, for example: from the presence of bacteria and its adverse effect on the quality and safety of the composition as foodstuff. The thermal treatment may include, but is not limited to, microwaving, blanching of the composition, or treating the composition by steam. The thermal treatment heating and cooling profile may change from one type of composition to another and is to be considered as an integral part of the disclosure. It should be noted that, a check to reassure that the composition is homogenous a can be achieved, for example, using organoleptic measurements. That is, by performing a visual inspection, in an embodiment, using a computer vision process. An alternative type of, inspection can be performed by using a sensor configuration to determine when the composition is homogenous.

At S140, a portion of a taste substance is added to the composition. The taste substance may be natural substances, such as, for example, vegetables, fruits, seeds, spices, seasonings, nutritional yeasts, oils, a combination thereof, etc. This stage is intended to provide the composition with the necessary flavoring that is suitable for the specific foodstuff being processed. In one embodiment, in addition to the one or more natural substances or instead of the one or more natural substances, artificial flavors maybe added. In an embodiment, the portion of the taste is between 0.25% to 2% of the food substance.

At S150, the composition is refrigerated in at least one mold. The refrigeration process stabilizes the texture of the composition and crystallization of the oils in the composition.

Optionally, at S160, the refrigerated composition is cut to portions, such as, for example, slices, dices, etc. In some example embodiments, at S170, portions of the refrigerated composition is packed, where the composition, now flavored and cut, is placed in a desired imperforate (sealed) package. The reason for using such a package is that in order to maintain an extended shelf life period of, for example, a month, it is necessary to prevent the atmosphere within the package from changing in an uncontrolled fashion. Thereafter, the operation is terminated.

It will be understood that the examples presented above are merely for illustration. Specific materials, ratios, and concentrations are not intended to act as limitations on the scope of the appended claims.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A process for preparing natural olive pulp-based food substance, comprising:
mixing a portion of olive pulp with at a portion of a plant-based protein into a composition;
heating the composition;
adding a portion of taste substance to the composition; and
refrigerating the composition in at least one mold, wherein the refrigerated composition is a natural pulp-based food substance.

2. The process of claim 1, further comprising:
producing olive pulp using a pulper machine.

3. The process of claim 1, wherein the portion of taste substance is selected from a group of: vegetables, fruits, seeds, spices, seasonings, nutritional yeasts, oils, and artificial flavors.

4. The process of claim 1, wherein the plant-based protein is selected from a group of: soy, lentils, hemp seeds, chia seeds, quinoa, spirulina, almonds, walnuts, cashews, pistachios, and brazil nuts.

5. The process of claim 1, further comprising:
cutting the refrigerated composition into portions.

6. The process of claim 5, wherein the cutting of the refrigerated composition is to at least one of: slices and dices.

7. The process of claim 5, further comprising:
packaging the portions of the compositions.

8. The process of claim 1, wherein the packaging is sealed.

9. The process of claim 1, wherein the portion of plan-based protein is up to 20% of the natural pulp-based food substance.

10. The process of claim 1, wherein the portion of olive pulp is up to 40% of the natural pulp-based food substance.

11. The process of claim 1, wherein the portion of taste substance is between 0.5% and 2% of the natural pulp-based food substance.

12. A natural olive pulp-based food substance, comprising:
mixture of a portion of olive pulp with at a portion of a plant-based protein; and
a portion of taste substance added to the mixture.

13. The substance of claim 12, wherein the portion of taste substance is any one of: vegetables, fruits, seeds, spices, seasonings, nutritional yeasts, oils, and artificial flavors.

14. The substance of claim 12, wherein the plant-based protein is any one of: soy, lentils, hemp seeds, chia seeds, quinoa, spirulina, almonds, walnuts, cashews, pistachios, and brazil nuts.

15. The substance of claim 12, wherein the portion of plan-based protein is up to 20% of the natural pulp-based food substance.

16. The substance of claim 12, wherein the portion of olive pulp is up to 40% of the natural pulp-based food substance.

17. The substance of claim 12, wherein the portion of taste substance is between 0.5% and 2% of the natural pulp-based food substance.
